(19) United States
(12) Patent Application Publication
(10) Pub. No.: US 2009/0140848 A1
(43) Pub. Date: Jun. 4, 2009

(54) SYSTEMS AND METHODS FOR A PROPERTY SENTINEL

(76) Inventors: Richard Rollins, Jacksonville, FL (US); David Lawson, Scottsdale, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/325,010

(22) Filed: Nov. 28, 2008

Related U.S. Application Data
(60) Provisional application No. 60/991,088, filed on Nov. 29, 2007.

(51) Int. Cl. G08B 19/00; H04N 7/18

(52) U.S. Cl. 340/521; 348/143; 348/E07.085

(57) ABSTRACT

Systems and methods for monitoring vacant structures according to various aspects of the present invention operate in conjunction with an environmental sensor system coupled to a repositionable housing. The environmental sensor system may detect an environmental condition by at least a first sensor, generate a first signal by the at least first sensor corresponding to the environmental condition, and transmit the first signal to a processor. The processor may be configured to process the first signal to at least one of identify a status of the environmental condition, identify an anomaly of the environmental condition, and store information about the environmental condition. The environmental sensor system may generate a second signal corresponding to the processed first signal, which may be transmitted to a database.

### CROSS-REFERENCES TO RELATED APPLICATIONS

This application claims the benefit of U.S. Provisional Patent Application No. 60/991,088, filed Nov. 29, 2007, and incorporates the disclosure of such application by reference.

### BACKGROUND OF THE INVENTION

Unoccupied property is vulnerable to damage due to a variety of natural and human causes. Natural causes may include harsh changes in weather (such as high temperatures and/or periods of freezing), water, sewer and gas leakage, vegetation overgrowth, and mold. Human causes may include theft, vandalism, arson, establishment of methamphetamine labs or other illegal activities, and the presence of homeless people who may act as squatters. Damage to unoccupied properties often leads to undesirable consequences including devaluation.

Recent increases in foreclosures, defaults and bankruptcies have increased the number of unoccupied properties on the market, resulting in increased liabilities for governments, investors, and lenders owning these properties. These entities are in need of systems to protect unoccupied property from damage.

Currently available security measures generally include fences, locks, smoke and/or humidity detectors, and conventional security systems. These security measures are directed at preventing one particular cause of damage, and are not a comprehensive way to monitor a property for a large variety of potential damage that may occur. Additionally, these security measures may require hardwired electricity and telephonic connections that may not be reliable and/or available in an unoccupied property. Currently, physical inspection is the only method for comprehensive protection. However, physical inspection is labor intensive and costly, and often is too infrequent to prevent acute causes of damage. Thus, there is a need for continuous, comprehensive monitoring of unoccupied property.

### SUMMARY OF THE INVENTION

Systems and methods for monitoring vacant structures according to various embodiments of the present invention may operate in conjunction with an environmental sensor system coupled to a repositionable housing. The environmental sensor system may detect an environmental condition by at least a first sensor, generate a first signal by the at least first sensor corresponding to the environmental condition, and transmit the first signal to a processor. The processor may be configured to process the first signal to at least one of identify a status of the environmental condition, identify an anomaly of the environmental condition, and/or store information about the environmental condition. The environmental sensor system may generate a second signal corresponding to the processed first signal, wherein the second signal may be transmitted to a database.

### BRIEF DESCRIPTION OF THE DRAWINGS

A more complete understanding of the present invention may be derived by referring to the detailed description and claims when considered in connection with the illustrative figures, which may not be to scale. In the following figures, like reference numbers refer to similar elements and steps throughout the figures.

FIG. 1 representatively illustrates a block diagram of a vacant structure monitoring system, in accordance with an exemplary embodiment of the present invention;

FIG. 2 representatively illustrates another exemplary embodiment of a vacant structure monitoring system that is camouflaged as a residential smoke detector, and comprises various functional components of the system; and

FIG. 3 representatively illustrates a flow diagram of method for detecting environmental conditions in a vacant structure, in accordance with an exemplary embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of techniques, technologies, and methods configured to perform the specified functions and achieve the various results. For example, the present invention may employ various processors, electronics, algorithms, processes, cameras, storage systems, statistical processing elements, memory elements, photo sensors, environmental sensors, power elements, light sources, communication elements, and the like, which may carry out a variety of functions. In addition, the present invention may be practiced in conjunction with any number of devices, and the systems described are merely exemplary applications. Further, the present invention may employ any number of conventional techniques for image acquisition, data acquisition, data analysis, data processing, data communication, component interfacing, and the like.

The ensuing detailed description provides exemplary embodiments only, and is not intended to limit the scope, applicability, or configuration of the invention. Instead, the ensuing detailed description of exemplary embodiments provides an enabling description for implementing an exemplary embodiment of the invention. Various changes may be made in the function and arrangement of elements without departing from the spirit and scope of the invention as set forth in the appended claims.

Specific details are given in the following description to provide a thorough understanding of the embodiments. The embodiments may be practiced, however, without these specific details. For example, circuits may be shown in block diagrams to avoid obscuring the embodiments in unnecessary detail. Likewise, well-known circuits, structures, and techniques may be shown without unnecessary detail to avoid obscuring the embodiments.

Further, embodiments may be described as a process which is depicted as a flowchart, flow diagram, data flow diagram, structure diagram, or block diagram. Although such illustrations may describe the operations as a sequential process, many of the operations may be performed in parallel or concurrently. In addition, the order of the operations may be re-arranged. A process is terminated when its operations are completed, but could have additional steps not included in the figure. A process may correspond to a method, a function, a procedure, a subroutine, a subprogram, and the like. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a medium, such as portable or fixed storage devices, optical storage devices, wireless channels and various other media capable of storing, containing or carrying instructions and/or data, and a processor may perform the necessary tasks. A code segment may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable technique or mechanism including memory sharing, message passing, token passing, network transmission, and the like.

Systems and methods according to various embodiments of the present invention may be applied to any system and/or method for monitoring vacant structures, such as vacant residential property, commercial properties, multiple dwelling units, properties under construction, water crafts, mobile homes, motor homes and the like. Certain representative implementations may include, for example, detection and/or monitoring applications, such as, changes in the environment to the vacant structure, changes to the surrounding property, and/or changes to the vacant structure itself. In an embodiment, systems and methods for monitoring vacant structures, according to various embodiments of the present invention, may operate in conjunction with a vacant structure monitoring system to provide a customizable, a remote or locally accessible, and/or a continuous comprehensive monitoring system for vacant structures.

Systems and methods according to various embodiments of the present invention may be embodied as a method, a system, a device, and/or a computer program product. Accordingly, such methods, systems, devices, and/or computer program products may take the form of an entirely software embodiment, an entirely hardware embodiment, or an embodiment combining aspects of both software and hardware.

In accordance with an exemplary embodiment, a vacant structure monitoring system and method may comprise a housing to house the various monitoring components, and in an embodiment, the housing may be camouflaged to resemble a typical residential smoke detector. In such a configuration, since the monitoring system resembles a typical home component, any unauthorized persons trespassing upon a vacant structure, will be unaware of the monitoring system, which will minimize the possibility of unauthorized persons from tampering with the monitoring device. In other words, identifying specific breaches to the vacant structure by unauthorized persons may be facilitated because any unauthorized persons will be unaware of the existence and/or location of the monitoring device. Thus, since any unauthorized persons will not know to disable the monitoring device, the monitoring device may operate as intended. Furthermore, even if notice is given by a warning sign at the vacant structure, any unauthorized persons will be unaware of how the vacant structure is being protected because the monitoring system is not obvious.

In accordance with another embodiment, the housing may not be camouflaged as a typical residential smoke detector, but rather, may take the form of any other typical residential home and/or commercial component. For example, the housing may be positioned proximate to: an air return or air duct, a decorative light fixture, a ceiling fan, a fuse box, an appliance, or any other component that may be discerned as a typical residential home and/or commercial component.

In still yet another exemplary embodiment, the housing may not resemble a typical residential home component at all, but rather, may be obviously placed in the vacant structure and/or appropriately labeled. In this embodiment, the mere visibility of the system may thwart any unauthorized persons from tampering with the vacant structure.

In some embodiments, the vacant structure may be monitored by a plurality of monitoring devices, wherein some monitoring components may be housed in one housing, such as, a camouflaged smoke detector, and other components may be housed in another housing, such as, another camouflaged smoke detector and/or other faux home components. Such plurality of monitoring devices may operate in conjunction with one another or act independently of one another.

In another exemplary embodiment of the present invention, the monitoring system may take advantage of home components that are already part of the vacant structure. For example, the actual smoke detector of the vacant structure may be removed or “gutted” of its components and replaced by monitoring components in accordance with the present invention. In this example, a person familiar with the residence will not recognize that any of the home components are out of place, or that other components, albeit camouflaged, have been added. In this example, a disgruntled homeowner, displaced from the home by foreclosure, may be identified if they attempt to vandalize the vacant structure.

In still yet another exemplary embodiment, the housing may not house all of the components of the monitoring system, but instead, the monitoring system may also comprise remote monitoring centers, remote devices and sensors coupled at various locations and/or coupled to various parts of the vacant structure, and the like.

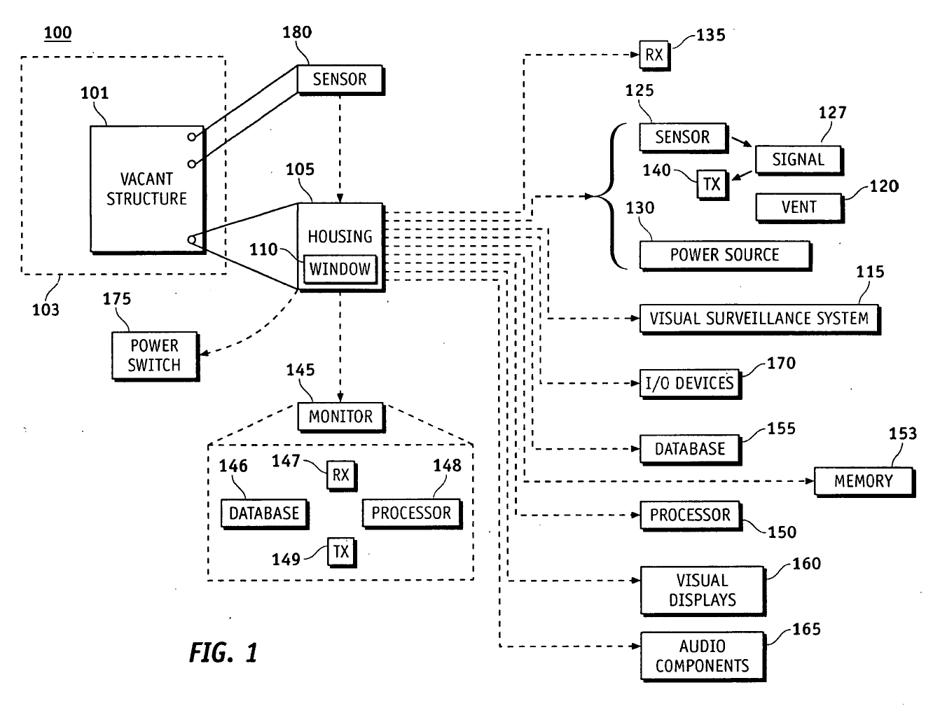

Referring now to FIG. 1, a vacant structure monitoring system 100, according to various exemplary embodiments of the present invention, may operate in conjunction with a housing 105. The housing 105 may function to mount, protect and/or conceal the various components of the vacant structure monitoring system 100. The housing 105 may be fixed and/or be repositionable at a vacant structure, and may be mounted in any suitable location within a vacant structure 101. The housing 105 may also be removed from the vacant structure 101 and re-mounted to any suitable location at another position at the vacant structure 101. In one embodiment, the housing 105 may be mounted inside the vacant structure 101, but in another embodiment the housing 105 may be mounted outside the vacant structure 101, such as, to an exterior wall. In still another embodiment, the housing 105 may be mounted apart from the vacant structure 101, but within the boundaries of the property 103, for example, on a patio, by a pool or spa, along a fence, and the like.

In accordance with an exemplary embodiment, the housing 105 may be mounted to the vacant structure 101 by any suitable mounting mechanism. For example, the housing 105 may be configured for “push-in” ceiling mount installation and/or de-installation so as to provide a safe location and/or easy access. In another embodiment, the housing 105 may be mounted to the vacant structure 101, such as, by an adhesive, a “push-in” wall mount, a clip, a strap, a fastener, a screw, a bolt, or any other mounting mechanism.

In accordance with an exemplary embodiment of the present invention, the housing 105 may comprise various operating and monitoring components. In an embodiment, the housing 105 may comprise an opening and/or a window 110 behind which a visual surveillance system 115, such as a video camera, may be located. In one embodiment, the window 110 may be tinted and/or colored, such as smoke-colored, to at least partially obscure viewing the inside of the housing 105, thereby preventing detection that housing 105 houses anything other than typical components consistent with what the housing 105 purports to resemble. Housing 105 may further comprise a vent 120 to allow circulation of the vacant structure's air so that a sensor 125 or multiple sensors located in the housing 105 may operate as intended, for example, the sensor 125 may be configured to detect various environmental changes to the vacant structure 101. The sensor 125 may also detect other conditional changes and/or anomalies to the vacant structure 101; moreover, an auxiliary sensor 180 may be located at other positions of the vacant structure 101. The housing 105 may also comprise a power source 130, such as a battery pack, to provide power to the various components housed within the housing 105. The housing 105 may also comprise a receiver 135, such as a radio receiver, and/or a transmitter 140 to: transmit and/or receive signals to communicate with the vacant structure monitoring system 100, communicate with components of the vacant structure monitoring system 100, and/or provide/receive any information to/from a remote monitoring facility 145. In an embodiment of the present invention, the housing 105 may also comprise a processor 150 to process information acquired by the various components of the vacant structure monitoring system 100 and/or to process information to or from the remote monitoring facility 145. The housing 105 may also comprise a database 155 and/or memory 153 to log/store information from the various vacant structure monitoring system 100 components and/or to log/store pre-programmed information, and the like.

In accordance with an exemplary embodiment, the housing 105 may house other components that are consistent with monitoring a vacant structure, for example, visual displays 160, such as screens, light-emitting-diodes (“LED”), lights, and the like; audio components 165, such as microphones and speakers; and Input/Output (“I/O”) devices 170, such as keypads, touch screens, voice recognition systems, biometric inputs, USB ports, memory card slots, AV inputs, Wi-Fi connections, cellular connections, and the like.

In accordance with an exemplary embodiment, the housing 105 may by coupled to an external on/off switch 175 that may operate to activate the vacant structure monitoring system 100. The external on/off switch 175 may also operate in conjunction with a light, such as a LED, which may indicate to a user that the vacant structure monitoring system 100 is activated.

With continued reference to FIG. 1, in an exemplary embodiment of the present invention, the vacant structure monitoring system 100 may comprise the sensor 125. The sensor 125 may comprise a single sensor, an array of sensors, or a sensor as part of a comprehensive environmental sensor system. The sensor 125 may comprise any sensory device that may be configured to monitor and/or detect changes to the vacant structure 101, to components of the vacant structure 101, and/or to the operability of the vacant structure monitoring system 100. In an embodiment, the sensor 125 may be configured to detect a wide variety of environmental conditions, for example, the sensor 125 may detect changes in motion, light, and/or sound inside and/or outside the vacant structure 101. In another embodiment, the sensor 125 may detect damage, for example, damage due to nature and/or theft. The sensor 125 may also detect damage to structural components of the vacant structure 101, for example, damage to the integrity of the foundation, walls, windows, appliances, plumbing and plumbing fixtures, electrical and electrical components, and the like. In another embodiment, the sensor 125 may detect chemical anomalies, such as, flammable fumes, toxic fumes, noxious fumes, smoke, and fire. In an embodiment, the sensor 125 may also detect changes in atmospheric conditions of the vacant structure 101, for example, changes in temperature, changes in humidity, changes in dust levels, and the like. In an embodiment, the sensor 125 may comprise any suitable sensor for detecting changes in utility services, for example, the sensor 125 may detect a change to: gas services, electric services, refuse removal services, sewer services, and/or water services. In still yet another embodiment, the sensor 125 may detect the presence, absence, and/or functional status of appliances, such as a water heater, a refrigerator, an air conditioning unit, a stove, a microwave, and/or the like.

The sensor 125 may also comprise any suitable sensor for detecting bio-hazardous materials. For example, in accordance with various embodiments of the present invention, the sensor 125 may detect airborne spores, allergens, molds, and the like. In another embodiment, the sensor 125 may detect harmful fumes, such as carbon monoxide, radon fumes, and/or fumes generated by methamphetamine production. In still another embodiment, the sensor 125 may comprise a plurality of sensors arranged into a sensor array to detect some or all of the environmental conditions described above.

In accordance with an exemplary embodiment, the sensor 125 may operate in conjunction with the other components of the vacant structure monitoring system 100. For example, the sensor 125, upon sensing a condition, may relay a signal, such as signal 127, to the transmitter 140 so as to transmit the information to the remote monitoring facility 145. In this example, the remote monitoring facility 145 may respond to the sensed condition and send response units to follow up at the vacant structure 101 for further investigation. In another embodiment, the sensor 125 may operate in conjunction with the visual surveillance component 115, such as a camera, and/or audio components 165 to possibly record the sensed condition. In still yet another embodiment, the sensor 125 may provide the signal 127 to the database 155 to record the sensed condition and/or provide the signal 127 to processor 150 for further analysis of the sensed condition. In accordance with another embodiment of the present invention, depending upon the sensed condition, the sensor 125 may operate in conjunction with the I/O device 170, for example, a cellular/CDMA/GSM type of connection. In this example, the sensed condition may require immediate attention, for example, from a fire or a burglary in progress. Thus, because time is of the essence, instead of relaying a signal to the remote monitoring facility 145 for analysis, the I/O device 170 may notify the appropriate fire or police departments for immediate response. In a further embodiment, the I/O device 170 may notify the remote monitoring facility 145 in addition to notifying the appropriate fire or police departments.

The sensor 125, according to various embodiments of the present invention, may operate in conjunction with the auxiliary sensor 180, wherein the auxiliary sensor 180 may be located at other areas of the vacant structure 101. The auxiliary sensor 180 may be configured to detect similar conditions described with respect to the sensor 125 and/or different conditions. For example, an auxiliary sensor 180 may be coupled to various structural components, appliances, and the like, and if an anomaly is detected, the auxiliary sensor 180 may relay a signal to other components of the system 100 for analysis, recordation, and/or response. Similar to the housing 105, the auxiliary sensor 180 may be camouflaged to resemble various typical household components.

In accordance with various exemplary embodiments, the sensor 125 and/or the auxiliary sensor 180 may be passive or active sensors. In one example, they may remain dormant until specifically activated by, for example, the remote monitoring facility 145. In another example, the sensors 125 and/or 180 may be configured to operate at only regular intervals, for example, continuously, on the hour, only during the daytime or nighttime, on specific dates, randomly, and the like.

In accordance with various embodiments of the present invention, the sensor 125 may be implemented in conjunction with: one or more microprocessors, for example the processor 150; RAM-storage devices, for example the memory 153; and/or any other suitable component for storing, communicating and/or responding to data. In one embodiment, the sensor 125, one or more processors 150, and the memory 153 may be implemented on a circuit board (not shown). The circuit board may be configured to communicate with the sensor 125 and a main (mother) board so as to support all embedded micro-processors, chips, memory, internal connections, and busses to all integrated devices, including interface cards and device specific adapter cards.

In accordance with an exemplary embodiment, the components of the vacant structure monitoring system 100 may be powered by one or more power sources 130. The power source 130 may comprise any suitable source of power such as a battery, a battery pack, a solar panel, a 110 AC current component, an international power adapter and/or converter, and/or a hardwire connection directly from the vacant structure 101. In one example, the battery and/or the battery pack may be a lithium battery, and in another example, the battery and/or battery pack may also be rechargeable. Power sources similar to power source 130 may also function as the source of power for the auxiliary sensor 180. In another embodiment, the power source 130 may be configured to power remote signals, status messages and/or other data transmissions. In one example, the power source 130 may be configured to facilitate transmission of a daily beacon GPS/SMS-type status message.

The vacant structure monitoring system 100 according to an embodiment of the present invention may comprise any visual surveillance system, for example, the visual surveillance system 115, for monitoring visual aspects of the vacant structure 101, for example, changes in the environment. In one embodiment, the visual surveillance system 115 may be implemented to detect changes in the appearance of an environment, such as changes in light, the detection and/or movement of foreign objects, people, household components, and the like. In an embodiment, the visual surveillance system 115 may provide up to a 360 degree view of an environment, such as the inside and/or outside of the vacant structure 101 and/or surrounding property 103. In one embodiment, the window 110 of the housing 105 may be configured to provide the visual surveillance system 115 with at least about a 120 degree view of the environment. Some exemplary embodiments of the visual surveillance system 115 may comprise: a camera, a video camera, an infrared camera, a camera sensitive to low light conditions, cellular observation devices, code division multiple access (“CDMA”) devices, cellular code division multiple access devices with embedded color, and the like. In one embodiment, the sensor 125 may also comprise a camera and/or a video camera with high resolution, low power requirement, and/or low lux level capability.

According to various exemplary embodiments, the visual surveillance system 115 may be configured to provide images in various computer readable formats such as jpeg, mpeg, video, picture files and/or MP3 and MP4 and/or other future technologies for image recordings, file compression and transmission.

The visual surveillance system 115 may also be configured for remote surveillance and/or remote access, for example, by remote monitoring facility 145. The visual surveillance system 115 may also be configured to be hidden, unnoticeable, and/or essentially noiseless in its operation. As described briefly above, the visual surveillance system 115 may reside within the housing 105, but other configurations may comprise visual surveillance system 115 to reside at other locations in and around vacant structure 101 and/or property 103.

Similar to the sensor 125 described above, and in accordance with various exemplary embodiments, the visual surveillance system 115 may be a passive or an active system. In one example, the visual surveillance system 115 may remain dormant until specifically activated by, for example, the remote monitoring facility 145. In another example, the visual surveillance system 115 may be configured to operate at only regular intervals, for example, continuously, on the hour, only during the daytime or nighttime, on specific dates, randomly, only during a sensed condition, and the like.

In conjunction with the visual surveillance system 115, the vacant structure monitoring system 100 may additionally comprise an infrared light source to provide light for the visual surveillance system 115 under low light conditions. In one embodiment, the infrared light source may be configured to emit infrared light in response to a sensed condition by the sensor 125, such as a motion sensor. Moreover, as part of a comprehensive surveillance system, the vacant structure monitoring system 100 may also comprise audio components 165 to detect, communicate with, and/or record audio signals of the vacant structure 101 and/or property 103. Audio components 165 may supplement the visual surveillance system to detect, communicate with, and/or record, for example, dialogue by an unauthorized person, such as dialogue between an unauthorized person and the remote monitoring facility 145, sound anomalies from household components, and the like, and may provide the audio information to the processor 150, the database 155, the memory 153, the remote monitoring facility 145, and/or authorized users of the monitoring system 100.

In accordance with an exemplary embodiment, the vacant structure monitoring system 100 may operate in conjunction with the processor 150. The processor 150 may be configured to further operate in conjunction with the transmitter 140 and/or the receiver 135, and exchange and/or store data within the database 155 by, for example, the sensor 125 and/or the auxiliary sensor 180. The processor 150 may transmit, receive, and/or exchange data through any system for exchanging data, such as, for example, the Internet, an intranet, an extranet, Wide Area Network (“WAN”), Local Area Network (“LAN”), WIFI, WIMAX, satellite communications, intermediate storage systems, radio frequency communications, a mesh network protocol such as Zigbee, wireless 802.11g and/or the like.

In an embodiment of the present invention, the processor 150, the memory 153, and/or the database 155 may comprise a machine-readable medium comprising machine-executable instructions, i.e., software, for performing machine-implementable processing of a signal, for example signal 127, to facilitate the operation of the various components of the vacant structure monitoring system 100. The various components may comprise the sensor 125, auxiliary sensor 180, visual surveillance system 115, audio components 165, and the like.

In accordance with an exemplary embodiment of the present invention, the vacant structure monitoring system 100 may comprise a wireless transmission device. The I/O device 170, as well as the transmitter 140, may be configured to operate as an exemplary wireless transmission device, wherein the transmission device may transmit and/or receive: information from the sensor 125, data, instructions, warnings, video, audio, status, and the like, of the vacant structure monitoring system 100 to authorized entities. Authorized entities may comprise, for example, the remote monitoring facility 145, an emergency department, a utility company, a web-site, a cell-phone, a PDA, an individual, and the like. Furthermore, the transmission device may transmit and/or receive information of varying importance, for example, sensed conditions that exceed pre-set thresholds or measured threats categorized by, for example, green, yellow, or red conditions as may be set by an administrator of the monitoring system 100.

In accordance with exemplary embodiments, the wireless transmission device, be it the I/O device 170 and/or the transmitter 140, may comprise data packet transmission to a data center, for example to the remote monitoring facility 145, via licenses for Global Positioning System (“GPS”), Global System Mobile (“GSM”), Code Division Multiple Access (“CDMA”), General Packet Radio Service (“GPRS”) data transfer, Enhanced Messaging Service (“EMS”); networking protocols such as Transmission Control Protocol (“TCP”) and the Internet Protocol (“IP”), Short Message Service (“SMS”), Long Term Evolution (“LTE”) systems, WIFI, WIMAX or any other type of transmission technology now known or further developed. In accordance with various embodiments, any wired, wireless, satellite, CDMA, and other transmission technologies may be transmitted in an encrypted fashion using known or further developed technologies.

In accordance with an exemplary embodiment, and as briefly described earlier with respect to the sensor 125 and the visual surveillance system 115, the transmission device may transmit in a passive or an active manner. In one example, the transmission device may remain dormant until specifically (manually) activated by, for example, the remote monitoring facility 145 or other authorized entity. In another example, the transmission device may be configured to transmit at only regular or automatic intervals and/or durations, for example, continuously, on the hour, only during the daytime or nighttime, on specific dates, randomly, only during a sensed condition, and the like.

In accordance with an exemplary embodiment of the present invention, the sensors 125 and/or 180, the visual surveillance system 115, the audio components 165, and/or any other components of monitoring system 100 may be configured to communicate with a remote database 146. Remote database 146 may operate in similar fashion to database 155 (or vice versa), and, in one example, the remote database 146 may comprise part of remote monitoring facility 145. In other exemplary embodiments, the remote database 146 may also reside independently from remote monitoring facility 145 and/or at other locations or as part of other systems. Data for the remote data base 146 may be transmitted through and/or by any suitable mechanism, including wired, wireless, satellite, cellular/CDMA, and/or any other transmission technologies. Data may also be encrypted prior to transmission for security. In an exemplary embodiment, remote database 146 may comprise of a customizable vacant structure 101 database to collect data in a specific manner for particular entities. The remote database 146 may comprise varying access for various users. For example the range of access to the remote database 146 may span from restricted access to partial access to complete access, and various users may comprise, property owners, staffed surveillance. stations, and other interested parties, such as realtors, property preservation companies, investors, and the like. The data may be historic data that is recalled for viewing or the data may comprise real time data, such as camera videos/pictures for ad hoc audits, and the like.

In accordance with various embodiments, the remote database 146 may comprise of and/or collect specific data elements pertinent to monitoring system 100. Exemplary data elements may comprise: a property's owner, name, and/or address; a realtor's owner, name, and/or address; a monitoring system unit number, a serial number, a system installer, a system location, system status messages, alarm and/or condition codes, system alert levels, sensor IDs, condition levels, dates, times, picture/video files, passwords/PIN codes, monitoring agent information, action history, and the like.

In accordance with another exemplary embodiment, the remote database 146 may provide for data mining, which may comprise not only accessing various information about a particular vacant structure monitoring system 100, but may also comprise administrative duties, such as sorting responses to inquiries for various statistics, revenue, and/or compensation. Moreover, data mining may be used for activity reporting, compensation and revenue generation purposes.

In accordance with an exemplary embodiment of the present invention, the vacant structure monitoring system 100 may comprise a remote staffed surveillance station, for example the remote monitoring facility 145. In an embodiment, the remote monitoring facility 145 may comprise a receiver 147 and/or a transmitter 149 to transmit and/or receive signals to communicate with the various vacant structure monitoring system 100 components at the vacant structure 101. In an embodiment of the present invention, the remote monitoring facility 145 may also comprise a processor 148 to process information acquired by the various components of the vacant structure monitoring system 100 and/or to process information to or from the remote monitoring facility 145. The remote monitoring facility 145 may also comprise the remote database 146 to log/store information from the various vacant structure monitoring system 100 components and/or to log/store pre-programmed information, and the like.

In accordance with an exemplary embodiment and similar to the housing 105, the remote monitoring facility 145 may comprise other components that are consistent with remotely monitoring the vacant structure 101, for example, visual displays, such as screens, LEDs, lights, and the like; audio components, such as microphones and speakers; and I/O devices, such as keypads, touch screens, voice recognition systems, biometric inputs, USB ports, memory card slots, AV inputs, Wi-Fi connections, cellular connections, and the like.

In accordance with an exemplary embodiment, the remote monitoring facility 145 may monitor data transmission from the vacant structure 101 property and the remote monitoring facility 145 may transmit, for example, notifications, warnings and/or instructions to owners of the property, police, fire stations, and/or utility companies regarding various sensed conditions. In one embodiment and as briefly mentioned earlier, sensed conditions may be categorized by an administrator to comprise a green, a yellow, or a red condition. For example, the sensor 125 and/or the auxiliary sensor 180 may communicate up to three different levels of activity including (1) active or a “green status,” (2) early alert warning for an abnormal condition or a “yellow status” and (3) serious condition or a “red alert”.

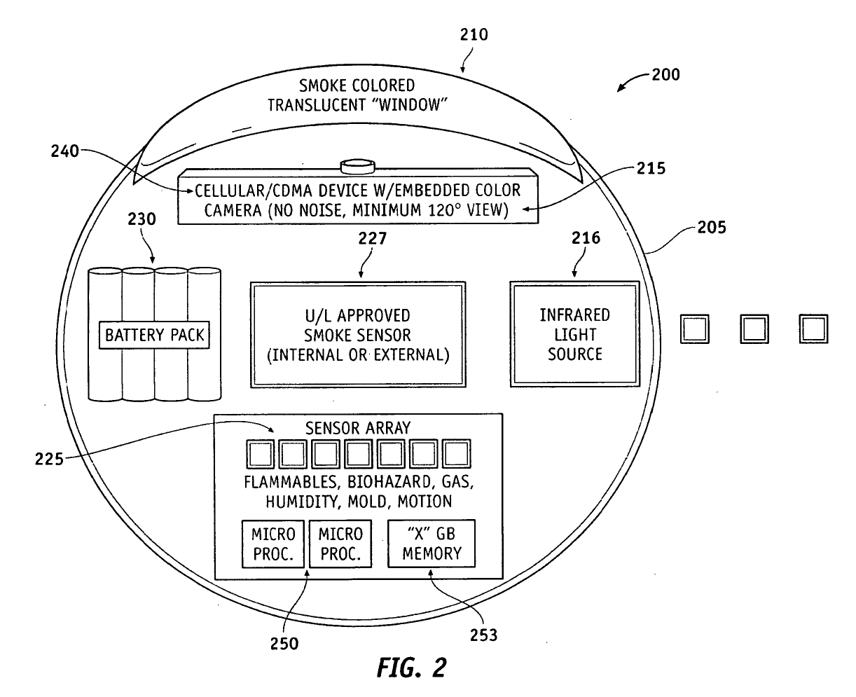

In accordance with an exemplary embodiment, and with reference to FIG. 2, an exemplary embodiment of the present invention is illustrated. The various components shown may be similar to corresponding elements described earlier and may comprise a housing 205, wherein the housing is configured to resemble a typical residential smoke detector; a window 210 further comprising a smoke colored translucent configuration to obscure the internal components from a casual observer; a power source 230 to provide power to the various housed components; and an infrared light source 216 to provide an appropriate light source for the camera 215. The exemplary embodiment may also comprise a cellular/CDMA/GSM/GPRS component 240 to act as a transmitter to transmit information detected by sensory array 225 that may detect various environmental conditions of a vacant structure (not shown). The cellular/CDMA/GSM/GPRS component 240 may also transmit information acquired by the camera 215 and/or the smoke sensor 227. The exemplary embodiment illustrated may also comprise micro-processors 250 and memory 253 to process/store acquired information from, for example, sensory array 225, camera 215, and/or smoke sensor 227. This embodiment is merely one example of a vacant structure monitoring system and this exemplary embodiment may, in other embodiments, comprise other components described, for example, audio components, vents, receivers, and the like.

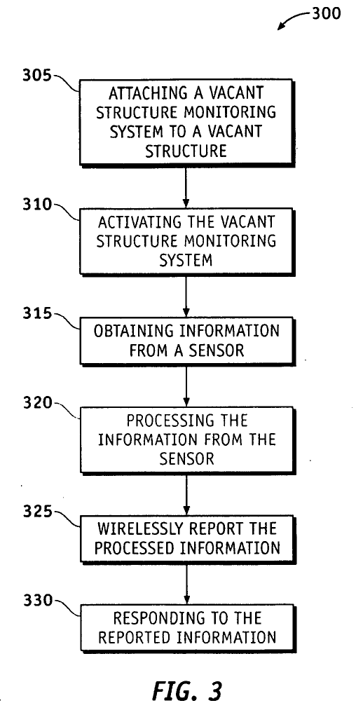

In accordance with an exemplary method of operation, and with reference to FIG. 3, an exemplary method (300) for monitoring a vacant structure according to various exemplary embodiments of the present invention may comprise: mounting a vacant structure monitoring system to a vacant structure (305); activating the vacant structure monitoring system (310); obtaining information from a sensor of the vacant structure monitoring system (315); processing the information from the sensor (320); wirelessly reporting the processed information (325); and responding to the reported information (330).

In accordance with the exemplary embodiment, mounting a vacant structure monitoring system to a vacant structure (305) may be similar to mounting as described earlier with respect to the housing 105, for example, by pushing the “push-in” ceiling mount coupled to the housing 105 into a wall and/or ceiling. In another example, an auxiliary sensor, similar to auxiliary sensor 180, may also be mounted to the vacant structure, such as to an exterior wall, another room in the vacant structure, or other household components.

In an exemplary embodiment of the present invention, activating the vacant structure monitoring system (310) may comprise switching an external on/off switch that is coupled to the housing 105 to the “on” position, for example power switch 175. Upon activation, the vacant structure monitoring system, for example, vacant structure monitoring system 100, may transmit an initial signal to a database, for example, remote database 146, which may indicate that the vacant structure monitoring system 100 is activated and properly working. The initial signal may also indicate the location of the vacant structure monitoring system 100 such as by a global positioning system, the time of day, an identifying number for the particular vacant structure monitoring system 100, and/or an initial signal corresponding to environmental conditions from a sensor, for example, sensor 125 and/or auxiliary sensor 180, and the like.

In accordance with the exemplary embodiment, obtaining information from a sensor of the vacant structure monitoring system (315) may comprise obtaining information from various sensors, for example, sensor 125 and auxiliary sensor 180, visual surveillance system 115, and/or audio components 165. Processing the information from the sensor (320) may comprise processing by a processor, for example processor 150 and/or processor 148 of remote monitoring facility 145. Wirelessly reporting the processed information (325) may comprise wirelessly reporting the processed information by CDMA, GSM, LTE, EMS, SMS to an authorized user, and responding to the reported information (330) may comprise responding as described, for example, by requesting assistance from a police or fire department, a utility company, and the like.

The particular embodiments shown and described are illustrative of the invention and its best mode and are not intended to otherwise limit the scope of the present invention in any way. Indeed, for the sake of brevity, conventional data processing, image acquisition, environmental condition detection, data transmission, and other functional aspects of the system (and components of the individual operating components of the systems) may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same. Likewise, the examples provided in the present description are merely examples, and the inclusion of such examples should not be regarded as limiting the scope of the disclosure. Instead, elements and systems illustrated by such examples should be construed, unless otherwise indicated, as including such possible implementations without being limited to any such possibilities.

We claim:

1. A system for monitoring vacant structures, comprising:
a housing that is repositionable and configured for temporary placement at a first location at a first vacant structure;
an environmental sensor system coupled to the housing and configured to:
detect an environmental condition by at least a first sensor;
generate a first signal by the at least first sensor corresponding to the environmental condition;
transmit the first signal to a processor, wherein the processor is configured to
process the first signal to at least one of identify a status of the environmental condition, identify an anomaly of the environmental condition, and store information about the environmental condition;
generate a second signal corresponding to the processed first signal; and
transmit the second signal to a database.

2. The system of claim 1, wherein the environmental sensor system is configured to detect by the at least first sensor at least one of: a motion, a light change, a sound change, a visual environmental change, a structural change, a gas, a biohazardous material, a temperature change, a humidity change, a household appliance change, and a utility service change.

3. The system of claim 2, wherein the biohazardous material comprises at least one of a mold, a flammable fume, a toxic fume, a chemical, smoke, and a fire.

4. The system of claim 2, wherein the utility service change comprises at least one of:
an electric service change, a gas service change, a water service change, a refuse service change, and a sewer service change.

5. The system of claim 1, wherein the at least first sensor is configured to transmit the first signal when the environmental condition achieves a pre-selected threshold value.

6. The system of claim 1, wherein the housing further comprises at least one of: an opening for a camera lens and a vent for air circulation.

7. The system of claim 6, wherein the opening for the camera lens comprises a colored translucent window.

8. The system of claim 1, wherein the housing is coupled to the at least first vacant structure by at least one of: an adhesive, a push-in ceiling mount, a push-in wall mount, a clip, a strap, and a fastener.

9. The system of claim 1, wherein the environmental sensor system further comprises a visual surveillance system to detect a visual change in the environment.

10. The system 9, wherein the visual surveillance system comprises at least one of: a camera, a video camera, an infrared camera, and a camera sensitive to low light conditions.

11. The system of claim 10, further comprising an infrared light source for providing an infrared light for the infrared camera.

12. The system of claim 11, wherein the infrared light source is activated by at least one of a motion and a programmed pre-selected time interval.

13. The system of claim 1, wherein the database is further configured to:
notify a user of the environmental condition; and
provide the user access to information about the environmental condition.

14. The system of claim 1, further comprising a power source to provide power to the housing and the environmental sensor system.

15. The system of claim 14, wherein the power source comprises at least one of a battery and a solar panel.

16. A machine-readable medium comprising machine-executable instructions for performing machine-implementable processing of the first signal as recited in claim 1.

17. A machine configured to perform machine-implementable processing of the first signal as recited in claim 1.

18. The system of claim 1, wherein the housing is camouflaged to resemble a residential smoke detector.

19. The system of claim 1, wherein the second signal corresponding to the processed first signal is transmitted wirelessly to the database by at least one of a code division multiple access communication, a satellite communication, a global system mobile communication, a long term evolution system, a General Packet Radio Service data transfer, a networking protocol, WIFI, WIMAX, a short message service, and an enhanced messaging service.

20. The system of claim 1, wherein the second signal corresponding to the first signal is encrypted before being transmitted to the database.

21. The system of claim 1, wherein the environmental sensor system transmits the first signal to the processor by at least one of a radio frequency transmission, an internet, an intranet, an extranet, a wide area network, a local area network, a satellite communication, an intermediate storage system, a mesh network protocol, a Zigbee protocol, and a wireless 802.11g protocol.

22. A system for monitoring vacant structures, comprising:
an at least one monitoring sensor configured to monitor a status of at least one component of the vacant structures and transmit a remote signal regarding the status of the vacant structure;
a repositionable housing camouflaged to resemble a smoke detector, configured for temporary placement at a first location at a first vacant structure, and to house system components, wherein the system components comprise;
an input sensor configured to receive the remote signal from the at least one monitoring sensor;
a processor to process the remote signal received by the input sensor;
a transmitter to transmit the processed remote signal, wherein the processed remote signal is transmitted wirelessly by at least one of a code division multiple access communication, a satellite communication, a global system mobile communication, a long term evolution system, a General Packet Radio Service data transfer, a networking protocol, WIFI, WIMAX, a short message service, and an enhanced messaging service; and
a power source to provide power to the system components;
a receiver to receive the transmitted signal; and
a database coupled to the receiver to manipulate the received signal.

23. The system of claim 22, wherein the at least one component of a vacant structure comprises at least one of: a motion, a light change, a sound change, a visual environmental change, a structural change, a gas, a biohazardous material, a temperature change, a humidity change, a household appliance change, and a utility service change.

24. The system of claim 23, wherein the biohazardous material comprises at least one of a mold, a flammable fume, a toxic fume, a chemical, smoke, and a fire.

25. The system of claim 23, wherein the utility service change comprises at least one of:
an electric service change, a gas service change, a water service change, a refuse service change, and a sewer service change.

26. The system of claim 22, wherein the at least one monitoring sensor is configured to transmit the remote signal when the monitoring sensor senses a pre-selected threshold setting.

27. The system of claim 22, wherein the housing further comprises at least one of: an opening for a camera lens and a vent for air circulation.

28. The system of claim 27, wherein the opening for the camera lens comprises a colored translucent window.

29. The system of claim 22, wherein the housing is coupled to the first vacant structure by at least one of: an adhesive, a push-in ceiling mount, a push-in wall mount, a clip, a strap, and a fastener.

30. The system of claim 22, wherein the system components further comprise a visual surveillance system to detect a visual change in the first vacant structure.

31. The system 30, wherein the visual surveillance system comprises at least one of: a camera, a video camera, an infrared camera, and a camera sensitive to low light conditions.

32. The system of claim 31, further comprising an infrared light source for providing an infrared light for the infrared camera.

33. The system of claim 32, wherein the infrared light source is activated by at least one of a motion and a programmed pre-selected time interval.

34. The system of claim 22, wherein the database is further configured to:
notify a user of the status of the at least one component of the vacant structures; and
provide the user access to information about the status of the at least one component of the vacant structures.

35. A machine-readable medium comprising machine-executable instructions for performing machine-implementable processing of the received signal as recited in claim 22.

36. A machine configured to perform machine-implementable processing of the received signal as recited in claim 22.

37. A method of identifying an environmental condition in a vacant structure, comprising:
detecting the environmental condition;
generating a first signal corresponding to the environmental condition;
transmitting the first signal to a processor, wherein the processor is configured to process the first signal to at least one of: identify a status of the environmental condition, identify an anomalous environmental condition, and store information about the environmental condition; and
generating a second signal corresponding to the environmental condition; and
transmitting the second signal to a remote monitoring station.

38. The method of claim 37, wherein the environmental condition detected comprises at least one of: a motion, a light change, a sound change, a visual environmental change, a structural change, a gas, a biohazardous material, a temperature change, a humidity change, a household appliance change, and a utility service change.

39. The method of claim 38, wherein the biohazardous material comprises at least one of a mold, a flammable fume, a toxic fume, a chemical, smoke, and a fire.

40. The method of claim 38, wherein the utility service change comprises at least one of:
an electric service change, a gas service change, a water service change, a refuse service change, and a sewer service change.

41. The method of claim 37, wherein the environmental condition is detected when the environmental condition achieves a pre-selected threshold value.

42. The method of claim 37, wherein the detected environmental condition comprises a visual change in the environment.

43. The method of claim 42, wherein the visual change in the environmental condition is detected by a visual surveillance system comprising at least one of: a camera, a video camera, an infrared camera, and a camera sensitive to low light conditions.

44. The method of claim 43, further comprising an infrared light source for providing light for the infrared camera.

45. The method of claim 44, wherein the infrared light source is activated by at least one of a motion and a programmed pre-selected time interval.

46. The method of claim 37, further comprising detecting the environmental condition at a plurality of locations in the vacant structure.

47. The method of claim 37, wherein the remote monitoring station performs at least one of:
notifying a user of the detected environmental condition;
and providing the user access to information about the detected environmental condition.

48. A machine-readable medium having machine-executable instructions for performing the machine-implementable method of processing of the first signal as recited in claim 37.

49. A machine configured to perform the machine-implementable method of processing of the first signal as recited in claim 37.

50. The method of claim 37, wherein the second signal corresponding to the environmental condition is transmitted wirelessly to the remote monitoring station by at least one of a code division multiple access communication, a satellite communication, a global system mobile communication, a long term evolution system, a General Packet Radio Service data transfer, a networking protocol, WIFI, WIMAX, a short message service, and an enhanced messaging service.

51. The method of claim 37, wherein the second signal corresponding to the environmental condition is encrypted before being transmitted to the remote monitoring station.

52. The method of claim 37, wherein the first signal corresponding to the environmental condition is transmitted to the processor by at least one of a radio frequency transmission, an internet, an intranet, an extranet, a wide area network, a local area network, a satellite communication, an intermediate storage system, a mesh network protocol, a Zigbee protocol, and a wireless 802.11g protocol.
